(19) United States
(12) Patent Application Publication
(10) Pub. No.: US 2026/0233642 A1
(43) Pub. Date: Aug. 13, 2026

(54) LONGITUDINAL ADJUSTER FOR A VEHICLE SEAT, VEHICLE SEAT, AND METHOD FOR PRODUCING A LONGITUDINAL ADJUSTER

(71) Applicant: Adient US LLC, Plymouth, MI (US)

(72) Inventor: Erik SPRENGER, Wermelskirchen (DE)

(21) Appl. No.: 19/535,089

(22) Filed: Feb. 10, 2026

(30) Foreign Application Priority Data
Feb. 11, 2025 (DE) 10 2025 104 896.7

(51) Int. Cl. B60N 2/06; B60N 2/07; B60N 2/22

(52) U.S. Cl. CPC B60N 2/067; B60N 2/0715; B60N 2/22

(57) ABSTRACT

A longitudinal adjuster for a motor vehicle seat may have at least one first seat rail having a first seat rail profile, at least one second seat rail which is movable relative to the first seat rail, a threaded spindle assigned to the first seat rail for interacting with a gear mechanism assigned to the second seat rail, and at least one spindle holder for fixing the threaded spindle to the first seat rail. The spindle holder may have at least one fastening element, which may be inserted through a corresponding opening in the first seat rail profile, and the spindle holder may be firmly connected to the first seat rail profile by plastic deformation of the fastening element. A vehicle seat having the adjuster and a method for producing a longitudinal adjuster are provided.

The invention relates to a longitudinal adjuster for a vehicle seat, in particular for a motor vehicle seat, with at least one first seat rail having a first seat rail profile, at least one second seat rail which is movable relative to the first seat rail, a threaded spindle assigned to the first seat rail for interacting with a gear mechanism assigned to the second seat rail, and at least one spindle holder for fixing the threaded spindle to the first seat rail. The invention also relates to a vehicle seat and to a method for producing a longitudinal adjuster.

### PRIOR ART

WO 2016/150791 discloses a longitudinal adjuster for a vehicle seat, in particular for a motor vehicle seat, with at least one first seat rail, at least one second seat rail which is movable relative to the first seat rail, a threaded spindle assigned to the first seat rail for interacting with a gear mechanism assigned to the second seat rail, and at least one spindle holder for fixing the spindle relative to the first seat rail.

DE 11 2018 000 009 B4 discloses a longitudinal adjuster for a vehicle seat, comprising a longitudinal adjuster with two rail pairs. Each rail pair has a first seat rail designed as a bottom rail, a second seat rail which is movable relative to the first seat rail and designed as a top rail, and a motor and gear unit with a threaded spindle. The threaded spindle is connected to the first seat rail. To retain the threaded spindle in the first seat rail, a spindle holder is arranged in each of the two end regions of the threaded spindle. A first spindle holder is designed as a block element which holds the threaded spindle in position, and a second spindle holder is designed as an L-shaped tab with a through-opening for the passage and retention of the threaded spindle.

In rail systems with spindle drives for seat longitudinal adjustment known from the prior art, for example from DE 11 2018 000 009 B4, L-shaped spindle holders are used to fasten the threaded spindle to a front end of the bottom rail. These spindle holders are angled either forwards or backwards. The L-shaped spindle holders often have a drawn collar in which a thread of the threaded spindle is inserted. The drawn collar is necessary to increase the material thickness in the region of the thread, for example from ca. 3 mm to ca. 5 mm. The angled design is necessary to provide installation space for a rivet of a riveted connection between the spindle holder and the bottom rail. In addition, an anti-rotation safeguard is required in order to position the spindle holder correctly.

### Object

The object of the invention is to improve a longitudinal adjuster of the type mentioned at the outset, in particular by providing a more cost-effective spindle holder. A vehicle seat having such a longitudinal adjuster is to be able to be produced more cost-effectively. The invention also has the object of simplifying a method for producing a longitudinal adjuster.

### Solution

According to the invention, this object is achieved by a longitudinal adjuster for a vehicle seat, in particular for a motor vehicle seat, with at least one first seat rail having a first seat rail profile, at least one second seat rail which is movable relative to the first seat rail, a threaded spindle assigned to the first seat rail for interacting with a gear mechanism assigned to the second seat rail, and at least one spindle holder for fixing the threaded spindle to the first seat rail, wherein the spindle holder has at least one fastening element, which is inserted through a corresponding opening in the first seat rail profile, and the spindle holder is firmly connected to the first seat rail profile by plastic deformation of the fastening element.

Since the spindle holder has at least one fastening element which is inserted through a corresponding opening in the first seat rail profile, and since the spindle holder is firmly connected to the first seat rail profile by plastic deformation of the fastening element, the spindle holder can be connected to the first seat rail profile by plastic deformation, without additional rivets as individual parts. The at least one fastening element itself can have the function of a rivet. This reduces costs for the additional components and their handling and also reduces the installation space for rivet heads in the interior of the first rail profile. The fastening elements can be plastically deformed by compression riveting, wobble riveting or hot riveting.

Preferably, the spindle holder is firmly connected to the first seat rail profile exclusively by plastic deformation of the at least one fastening element. Preferably, the spindle holder is firmly connected to the first seat rail profile exclusively by the at least one fastening element.

The spindle holder can have at least two, in particular exactly two, fastening elements which are inserted through in each case a corresponding opening in the first seat rail profile. The spindle holder can be firmly connected to the seat rail profile by plastic deformation of the fastening elements. By using at least two fastening elements, it is possible to dispense with an additional anti-rotation safeguard for the spindle holder in order to position the spindle holder in the correct position relative to the first seat rail profile during mounting of the first seat rail.

The at least one fastening element can be designed as a tab. The spindle holder can be produced from sheet metal, in particular sheet steel. The spindle holder can be punched out from sheet metal, in particular sheet steel. The at least one fastening element can be designed as a sheet metal tab, in particular as a sheet steel tab. The tab can have a material thickness of 4 mm to 6 mm. The tab can have the same material thickness as the other regions of the spindle holder. The fastening element can have a substantially rectangular cross-section. The tab can have a substantially rectangular cross-section.

The spindle holder can be in one piece. The spindle holder can be manufactured in one piece. The spindle holder can have an internal thread into which the threaded spindle, in particular a trapezoidal thread of the threaded spindle, is screwed. The length of the internal thread can correspond to the material thickness of the spindle holder, being in particular 4 mm to 6 mm.

The spindle holder can be designed as a flat, planar component. The spindle holder can be designed as a sheet metal component, in particular a sheet steel component. The spindle holder can be designed as a cast component, in particular as an injection-moulded component. The spindle holder can be designed as a sintered part. The spindle holder can be produced in 3D printing.

According to the invention, the object is also achieved by a vehicle seat, in particular a motor vehicle seat, having a longitudinal adjuster according to the invention.

According to the invention, the object is also achieved by a method for producing a longitudinal adjuster according to the invention, comprising at least the following method steps:
a) provision of the spindle holder;
b) insertion of the at least one fastening element of the spindle holder into the corresponding opening of the first seat rail profile;
c) plastic deformation of the at least one fastening element, in particular on a side of a profile base of the first seat rail profile facing away from the threaded spindle.

In summary, and in other words, the invention makes available a rail system with a spindle drive, in which a cost-effective and space-optimized spindle holder for a threaded spindle is used. The spindle holder is designed as a flat component. The material thickness of the spindle holder is great enough for a thread, in particular a trapezoidal thread, of the threaded spindle to be inserted directly into the spindle holder, in particular screwed in. For example, the material thickness of the spindle holder is 4 to 6 mm. At one end, preferably a lower end, the spindle holder has two rivet lugs which are inserted through two corresponding holes in the bottom rail. These two rivet lugs are then riveted. The riveting method used for this purpose is,

for example, compression riveting, wobble riveting or hot riveting. By virtue of the two rivet lugs, no further anti-rotation safeguard is needed and it is possible to do without rivets as individual parts.

### DESCRIPTION OF THE FIGURES

The invention is explained in more detail below on the basis of an example known from the prior art, illustrated in the figures, and on the basis of an advantageous exemplary embodiment according to the invention. However, the invention is not limited to this exemplary embodiment according to the invention. In the figures:

FIG. 1 shows a schematic side view of a vehicle seat according to the invention,

FIG. 2 shows a front view of a first seat rail known from the prior art,

FIG. 3 shows a section through the first seat rail, known from the prior art, along the line III – III in FIG. 2,

FIG. 4 shows a front view of a first seat rail according to the invention,

FIG. 5 shows a section through the first seat rail according to the invention, along the line V – V in FIG. 4,

FIG. 6A shows a spindle holder of the first seat rail according to the invention from FIG. 4, before insertion into a first seat rail profile,

FIG. 6B shows the spindle holder of FIG. 6A after insertion into the first seat rail profile, before riveting of the spindle holder, and

FIG. 6C shows the spindle holder of FIG. 6A after insertion into the first seat rail profile and after riveting of the spindle holder.

### DETAILED DESCRIPTION

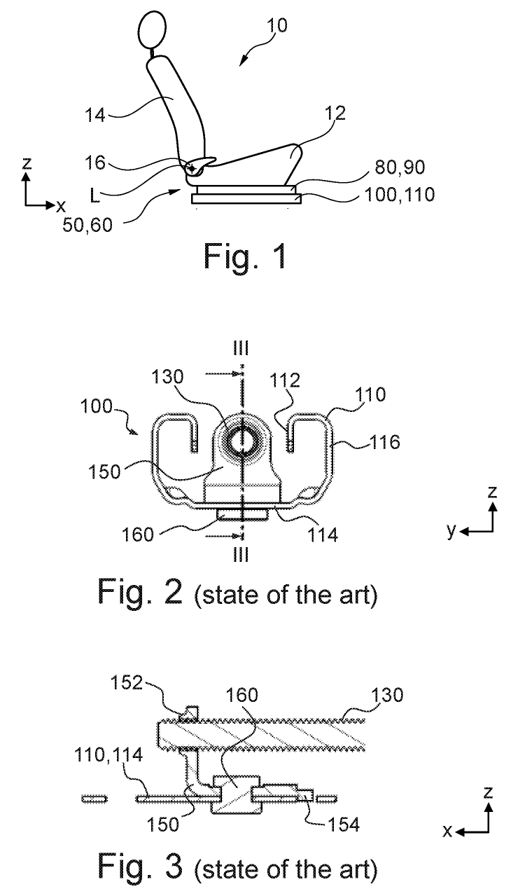

FIG. 1 shows a vehicle seat 10 according to the invention in a highly schematic representation.

The vehicle seat 10 is described below using three spatial directions extending perpendicularly with respect to one another. With a vehicle seat 10 installed in the vehicle, a longitudinal direction x extends largely horizontally and preferably parallel to a vehicle longitudinal direction, which corresponds to the normal direction of travel of the vehicle. A transverse direction y extending perpendicularly with respect to the longitudinal direction x is likewise oriented horizontally in the vehicle and extends parallel to a vehicle transverse direction. A vertical direction z extends perpendicularly with respect to the longitudinal direction x and perpendicularly with respect to the transverse direction y. With a vehicle seat 10 installed in the vehicle, the vertical direction z extends parallel to the vehicle vertical axis.

The terms used for positions and directions, such as left, right, front, rear, above, below, transversely, laterally and on both sides, are with reference to a viewing direction of an occupant seated in a customary seating position on a seat surface of a seat substructure 12 (seat part) of the vehicle seat 10, wherein the vehicle seat 10 is installed in the vehicle in a suitable position of use for passenger transport and is oriented as usual in the direction of travel. However, the vehicle seat 10 can also be installed in a different orientation, for example transversely with respect to the direction of travel. Unless described to the contrary below, the vehicle seat 10 is constructed in a mirror-symmetrical manner with respect to a plane extending perpendicularly to the transverse direction y.

A backrest 14 is connected on both sides, by means of a respective fitting 16, to the seat substructure 12 so as to be adjustable in inclination about a backrest pivot axis L.

The seat substructure 12 has a seat longitudinal adjuster 50 for longitudinal adjustment of the vehicle seat 10. The seat longitudinal adjuster 50 in the present case comprises a seat rail pair 60 on both sides. Each of the two seat rail pairs 60 has a first seat rail 100 and a second seat rail 80. In the exemplary embodiment, the first seat rail 100 is designed as a bottom rail and is connectable to a vehicle floor, in particular by means of screws. In the exemplary embodiment, the second seat rail 80 is a top rail connected to a longitudinally adjustable part of the seat substructure 12. The second seat rail 80 is guided longitudinally movably on the first seat rail 100. The second seat rail 80 is longitudinally movable relative to the first seat rail 100 by means of an electromotively driven spindle drive. In a modification (not shown in the figures) of the exemplary embodiment, the first seat rail can be a top rail and the second seat rail can be a bottom rail.

The two seat rail pairs 60 are largely mirror-symmetrical to each other, so that only one seat rail pair 60 is described below. The description applies to both seat rail pairs 60, unless otherwise described below.

The first seat rail 100 has a first seat rail profile 110, in particular from worked sheet steel. The second seat rail 80 has a second seat rail profile 90, in particular from worked sheet steel.

When mounted in the vehicle, the first seat rail profile 110 and the second seat rail profile 90 each extend largely parallel to the longitudinal direction x, there being the possibility of a small acute angle to the longitudinal direction x. The first seat rail profile 110 and the second seat rail profile 90 mutually engage behind each other with their profiles. The first seat rail profile 110 has an upwardly open, substantially C-shaped profile cross-section, with downwardly bent profile end portions 112 at the ends. The first seat rail profile 110 has a substantially planar profile base 114, adjoined on both sides by upwardly bent, outer profile side portions 116. At their ends opposite to the profile base 114, the upwardly bent profile side portions 116 transition into the downwardly bent profile end portions 112. The profile base 114 in the present case forms a web of the C-shaped profile cross-section. The two profile side portions 116 in the present case each form a flange of the C-shaped profile cross-section.

The second seat rail profile 90 of the second seat rail 80 has a downwardly open, substantially U-shaped profile cross-section with upwardly bent end portions. The second seat rail profile 90 has a substantially planar web, adjoined on both sides, when viewed parallel to the transverse direction y, by downwardly bent limbs. At their ends opposite to the web, the downwardly bent limbs transition into the upwardly bent end portions.

The upwardly bent end portions of the second seat rail profile 90 are guided in the outer profile end portions 112 of the first seat rail profile 110. In lower rolling-body raceways and upper rolling-body raceways, rolling bodies are arranged between the first seat rail profile 110 and the second seat rail profile 90, which rolling bodies facilitate a relative movement between the second seat rail profile 90 and the first seat rail profile 110.

The two seat rail profiles 90, 110 form an installation space between them. Within the installation space, a threaded spindle 130 connected to the first seat rail profile 110 is arranged in the longitudinal direction x of the seat rail pair 60, with a thread, in particular a trapezoidal thread, being formed on the outside of the spindle. A gear mechanism, driveable by a motor of the longitudinal adjuster 50 and mounted in a housing permanently connected to the second seat rail 80, has, in addition to further gear elements in geared connection with each other, a spindle nut which is in geared engagement with the threaded spindle 130 and movable thereto. When the motor drives the gear mechanism, the latter moves along the threaded spindle 130, entraining the second seat rail 80 and a superstructure of the vehicle seat 10 connected thereto.

FIGS. 2 and 3 show a first seat rail 100 known from the prior art. The first seat rail 100 has a first seat rail profile 110, a threaded spindle 130, and at least one spindle holder 150. A spindle holder 150 is fastened to a front end of the threaded spindle 130. Preferably, a further spindle holder is also fastened to a rear end of the threaded spindle 130. The spindle holder 150 serves to fasten the threaded spindle 130 to the first seat rail profile 110 of the first seat rail 100. By means of the spindle holder 150, the threaded spindle 130 is spaced apart from the profile base 114 of the first seat rail profile 110 and fixed relative thereto.

The spindle holder 150 is angled to the rear in an L-shape. The spindle holder 150 has a drawn collar 152 with an internal thread into which the threaded spindle 130 is screwed. The drawn collar 152 is necessary to increase the material thickness of the spindle holder 150 to a necessary dimension in the region of the thread. The L-shape of the spindle holder 150 is required to provide installation space for a rivet 160 of a riveted connection between the spindle holder 150 and the first seat rail profile 110. In addition, the spindle holder 150 has an anti-rotation safeguard 154 in order to position the spindle holder 150 in the correct position relative to the first seat rail profile 110 during the mounting of the first seat rail 100.

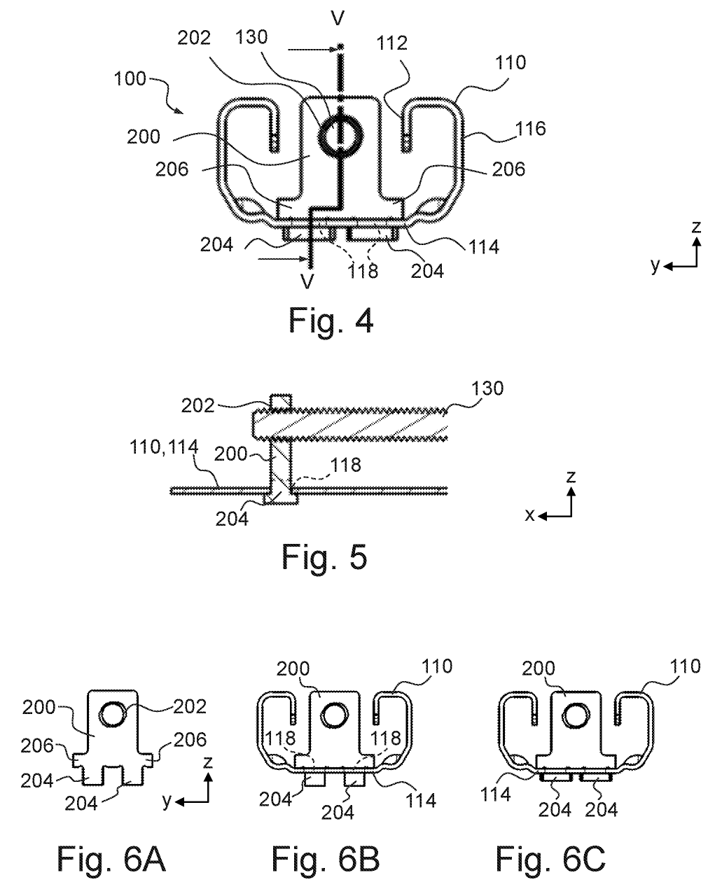

FIGS. 4 and 5 show an exemplary embodiment of a first seat rail 100 of a longitudinal adjuster 50 according to the invention with two seat rail pairs 60, the two seat rail pairs 60 each having a first seat rail 100, a second seat rail 80 which is movable relative to the first seat rail 100, a threaded spindle 130 assigned to the first seat rail 100 for interacting with a gear mechanism assigned to the second seat rail 80, and at least one spindle holder 200 for fixing the threaded spindle 130 relative to the first seat rail 100.

The spindle holder 200 is a flat, planar component, in particular made from sheet steel. For example, a material thickness of the spindle holder 200 can be 4 mm to 6 mm. The spindle holder 200 in the present case is mirror symmetrical with respect to a plane, in particular with respect to a plane extending parallel to the transverse direction y and parallel to the vertical direction z. This plane can at the same time be the plane of symmetry of the first seat rail profile 110.

The spindle holder 200 has a hole with an internal thread 202 into which the threaded spindle 130 is screwed. The length of the internal thread 202 corresponds to the material thickness of the spindle holder 200, which is in a range between 4 mm and 6 mm, for example.

To connect the spindle holder 200 to the first seat rail 100, the spindle holder 200 has two fastening elements 204, which are designed as tabs. The two fastening elements 204 are designed in one piece with the rest of the spindle holder 200. The two fastening elements 204 are inserted into a corresponding opening 118 of the first seat rail profile 110. On a side of the profile base 114 of the first seat rail profile 110 facing away from the threaded spindle 130, the fastening elements 204 are plastically deformed, in particular riveted, so that the spindle holder 200 is firmly connected to the first seat rail profile 110. The fastening elements 204 can be plastically deformed by compression riveting, wobble riveting or hot riveting.

Two lateral support contours 206 extend parallel to the transverse direction y and serve to laterally support the spindle holder 200 from tilting moments acting around the longitudinal axis x. In addition, the lateral support contours 206 can limit the depth of insertion of the fastening elements 204 into the corresponding openings 118. The spindle holder 200 has a largely rectangular base contour from which the two fastening elements 204 protrude downwards and the two support contours 206 protrude laterally.

FIGS. 6A to 6C show individual states during a method for producing the longitudinal adjuster 50 according to the invention described above. FIG. 6A shows a spindle holder 200 which is provided for mounting in the first seat rail profile 110, and of which the fastening elements 204 are still undeformed. FIG. 6B shows a preliminary assembly in which the fastening elements 204 of the spindle holder 200 are already inserted into the corresponding openings 118 of the first seat rail profile 110. The fastening elements 204 are still undeformed, and therefore the spindle holder 200 is not yet firmly connected to the seat rail profile 110. FIG. 6C shows a state after a plastic deformation of the fastening elements 204 has taken place on a side of the profile base 114 of the first seat rail profile 110 facing away from the threaded spindle 130. The fastening elements 204 can be plastically deformed by compression riveting, wobble riveting or hot riveting.

The features disclosed in the above description, in the claims and in the figures may be both individually and collectively of importance for the implementation of the

invention in its various configurations, insofar as they remain within the scope of protection of the claims.

### List of reference signs

10 vehicle seat

12 seat substructure

14 backrest

16 fitting

50 longitudinal adjuster

60 seat rail pair

80 second seat rail

90 second seat rail profile

100 first seat rail

110 first seat rail profile

112 profile end portion

114 profile base

116 profile side portion

118 opening

130 threaded spindle

150 spindle holder

152 drawn collar

154 anti-rotation safeguard

160 rivet

200 spindle holder

202 internal thread

204 fastening element

206 support contour

L backrest pivot axis

x longitudinal direction

y transverse direction

z vertical direction

What is claimed is:

1. A longitudinal adjuster for a vehicle seat, with at least one first seat rail having a first seat rail profile, at least one second seat rail which is movable relative to the first seat rail, a threaded spindle assigned to the first seat rail for interacting with a gear mechanism assigned to the second seat rail, and at least one spindle holder for fixing the threaded spindle to the first seat rail, characterized in that the spindle holder has at least one fastening element, which is inserted through a corresponding opening in the first seat rail profile, and the spindle holder is firmly connected to the first seat rail profile by plastic deformation of the fastening element.

2. The longitudinal adjuster according to claim 1, characterized in that the spindle holder has at least two fastening elements, which are inserted through in each case a corresponding opening in the first seat rail profile, and the spindle holder is firmly connected to the seat rail profile by plastic deformation of the fastening elements.

3. The longitudinal adjuster according to claim 2, wherein the spindle holder has exactly two fastening elements.

4. The longitudinal adjuster according to claim 1, characterized in that the at least one fastening element is designed as a tab.

5. The longitudinal adjuster according to claim 4, wherein the at least one fastening element is a sheet metal tab.

6. The longitudinal adjuster according to claim 4, characterized in that the tab has a material thickness of 4 mm to 6 mm.

7. The longitudinal adjuster according to claim 1, characterized in that the spindle holder is manufactured in one piece.

8. The longitudinal adjuster according to claim 1, characterized in that the spindle holder has an internal thread into which the threaded spindle is screwed.

9. The longitudinal adjuster according to claim 6, characterized in that a length of an internal thread of the spindle holder corresponds to a material thickness of the spindle holder.

10. The longitudinal adjuster according to claim 9, wherein the material thickness of the spindle holder is 4 mm to 6 mm.

11. The longitudinal adjuster according to claim 1, characterized in that the spindle holder is designed as a flat, planar component.

12. The longitudinal adjuster according to claim 11, wherein the spindle holder is a sheet metal component.

13. A vehicle seat, having the longitudinal adjuster according to claim 1.

14. The longitudinal adjuster according to claim 1, produced according to at least the following method steps:
a) provision of the spindle holder;
b) insertion of the at least one fastening element of the spindle holder into the corresponding opening of the first seat rail profile;
c) plastic deformation of the at least one fastening element.

15. The longitudinal adjuster according to claim 14, wherein the plastic deformation of the at least one fastening element is on a side of a profile base of the first seat rail profile facing away from the threaded spindle.
